(19) United States
(12) Patent Application Publication
(10) Pub. No.: US 2017/0221604 A1
(43) Pub. Date: Aug. 3, 2017

(54) GROUND BAR FOR MICRO-COAXIAL WIRES IN HDMI CABLES

(71) Applicant: Apple Inc., Cupertino, CA (US)

(72) Inventors: Joshua J. Pong, San Jose, CA (US); Colin J. Abraham, Mountain View, CA (US); Jay E. Sha, Menlo Park, CA (US); Jongbae Park, Santa Clara, CA (US); Chang Liu, San Jose, CA (US)

(73) Assignee: Apple Inc., Cupertino, CA (US)

(21) Appl. No.: 15/488,393

(22) Filed: Apr. 14, 2017

(51) Int. Cl. H01B 7/08; H01R 43/00; H01R 12/62; H01R 13/641; H01B 9/00; H01R 9/05

(52) U.S. Cl. CPC H01B 7/08; H01B 9/003; H01R 9/0515; H01R 12/62; H01R 13/641; H01R 43/00

(57) ABSTRACT

Cable assemblies that may convey high speed signals while providing reduced signal noise, radiation, and susceptibility to interference. These and other examples may be readily manufactured. These and other examples may provide cables having a reduced thickness.

### BACKGROUND

Power and data may be provided from one electronic device to another using cable assemblies. These cable assemblies may include cables having one or more conductors.

Connector inserts may be located at each end of these cables and may be inserted into connector receptacles in the communicating or power transferring electronic devices.

The conductors in the cable may connect to contacts in the connector inserts to convey high-speed signals along with power supplies and other signals. These high-speed signals may have fast rising and falling edges that contain high-frequency components. These high-frequency components may couple to other high-speed signals, power supplies, and other signals in the cable assembly. These high-frequency components may also radiate away from the cable assemblies and interfere with wired and wireless signals of nearby or associated devices. Further, other wired or wireless signals from nearby or associated devices may couple onto the conductors conveying the high-speed signals. Using a conductor that is susceptible to interference may cause the high-speed signal to be degraded and may make data transfers less reliable.

Various electronic devices may generate a large demand by consumers. Yield problems may impair a manufacturer's ability to deliver the electronic devices to fill this demand. Accordingly, it may be desirable to provide cable assemblies that may be readily manufactured even while meeting the above reductions in radiation and susceptibility to interference.

The electronic devices that these cable assemblies connect to have been becoming thinner with each succeeding generation. Some are becoming so thin that they may be thinner in at least one dimension than their corresponding cable. Accordingly, it may be desirable to provide a thinner cable having the above attributes.

Thus, what is needed are cable assemblies that may convey high speed signals while providing a reduction in radiation and susceptibility to interference, while also being readily manufactured and having a reduced thickness.

### SUMMARY

Accordingly, embodiments of the present invention may provide cable assemblies that may convey high speed signals while providing a reduction in radiation and susceptibility to interference, while also being readily manufactured and having a reduced thickness.

An illustrative embodiment of the present invention may provide cable assemblies that may convey high speed signals while providing a reduction in radiation and susceptibility to interference. These and other embodiments of the present invention may provide improved shielding for connector inserts of a cable assembly. This shielding may substantially surround a rear, top, bottom, and sides of the connector inserts of the cable assembly, leaving a front opening unshielded for mating with a connector receptacle. The shielding may also include seams having reduced straight-line segment lengths and limited gaps to reduce electromagnetic emissions. This shielding may reduce radiation from high-speed signals conveyed by the cable assembly that may interfere with wired and wireless signals of nearby or associated devices. This shielding may also reduce the cable assembly's susceptibility to interference from wired and wireless signals of nearby or associated devices. The shielding may also absorb stress placed on the connector insert during insertion into and extraction from a connector receptacle, thereby protecting internal solder connections.

These and other embodiments of the present invention may reduce interference and cross-talk among high-speed signals in a cable assembly by using micro-coaxial wires as conductors. The micro-coaxial wires may include signal wires that are individually shielded and the shielding may be terminated in each connector insert in the cable assembly. The terminations may reduce insertion losses for the signals conveyed by the micro-coaxial wires. To reduce skew, particularly in differential pair signals, the micro-coaxial wires may be trimmed to be the same length and may be manufactured to have the matched impedances. In an HDMI connector, eight micro-coaxial wires may be used to convey four differential signal pairs. These or other types of conductors may be used to convey power, ground, and other signals.

An illustrative embodiment of the present invention may provide cable assemblies that may be readily manufactured by providing a ground bar that may be used to terminate the shields of the micro-coaxial wires to ground. These terminations may reduce insertion losses for the signals conveyed by these micro-coaxial wires. The ground bar may be located in a connector insert between the cable and an internal housing that supports contacts for mating with a connector receptacle. The ground bar may include alignment features that may align the ground bar to the internal housing. The shields of the micro-coaxial wires may be hot-bar soldered to the ground bar while the signal wires may be hot-bar soldered to contact tails of the contacts in the internal housing. A height of the ground bar may be varied such that the micro-coaxial wires do not need to be bent or angled for the connections to the shields and signal wires to be made. The ground bar may include one or more openings to act as heat breaks to prevent heat from dissipating too quickly during soldering.

An illustrative embodiment of the present invention may provide cable assemblies having a reduced thickness by providing an internal strain relief for the cable. This may eliminate the need for a conventional strain relief that typically wraps around an outside jacket of a cable. These and other embodiments of the present invention may provide a cable having hollow tube in or near its center. The hollow tube may have one of a number of different cross-sections. For example, the hollow tube may have a star-shaped cross section, a circular cross-section, or other shaped cross-section. Stiffening rods may be inserted into the ends of hollow tube. The stiffening rods may prevent the cables from being bent at a localized point and may instead distribute the bend radius over the length of rod. In these and other embodiments of the present invention, the hollow tube and rod may be replaced by a plastic or nylon rod. In these and other embodiments of the present invention, these hollow tubes and rods may be in or near a center of the cable or elsewhere in or on the cable.

While embodiments of the present invention may be useful in High-Definition Multimedia Interface® (HDMI) cable assemblies, these and other embodiments of the present invention may be used in other types of cable assemblies for different interfaces.

In various embodiments of the present invention, contacts, shells, ground bars, and other conductive portions of a cable assembly may be formed by stamping, metal-injection molding, machining, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions, such as the external housings, internal housings, and other structures may be formed using injection or other molding, 3-D printing, machining, or other manufacturing process. The nonconductive portions may be formed of silicon or silicone, rubber, hard rubber, plastic, nylon, liquid-crystal polymers (LCPs), ceramics, or other nonconductive material or combination of materials.

Embodiments of the present invention may provide cable assemblies and connector inserts that may connect to various types of devices, such as portable computing devices, tablet computers, desktop computers, laptops, all-in-one computers, wearable computing devices, cell phones, smart phones, media phones, storage devices, portable media players, navigation systems, monitors, power supplies, video delivery systems, adapters, remote control devices, chargers, and other devices. These cable assemblies may provide pathways for signals that are compliant with various standards such as one of the Universal Serial Bus (USB) standards including USB Type-C, one of the HDMI standards, such as 1.4 or 2.0, Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. Other embodiments of the present invention may provide cable assemblies that may be used to provide a reduced set of functions for one or more of these standards. In various embodiments of the present invention, these interconnect paths provided by these cable assemblies may be used to convey power, ground, signals, test points, and other voltage, current, data, or other information.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates an electronic system that may be improved by the incorporation of embodiments of the present invention;

FIG. 2 illustrates a cable assembly according to an embodiment of the present invention;

FIG. 3 is a top-side exploded view of a connector insert according to an embodiment of the present invention;

FIG. 4 is a bottom-side exploded view of a connector insert according to an embodiment of the present invention;

FIG. 5 is an exploded view of a portion of a connector insert according to an embodiment of the present invention;

FIG. 6 illustrates a portion of a connector insert according to embodiments of the present invention;

FIG. 7 illustrates a ground bar according to an embodiment of the present invention;

FIG. 8 illustrates a cross-section of a cable according to an embodiment of the present invention;

FIG. 9 illustrates an internal strain relief according to an embodiment of the present invention; and

FIG. 10 illustrates a cross-section of a cable including an internal strain relief according to an embodiment of the present invention.

### DESCRIPTION OF ILLUSTRATIVE EMBODIMENTS

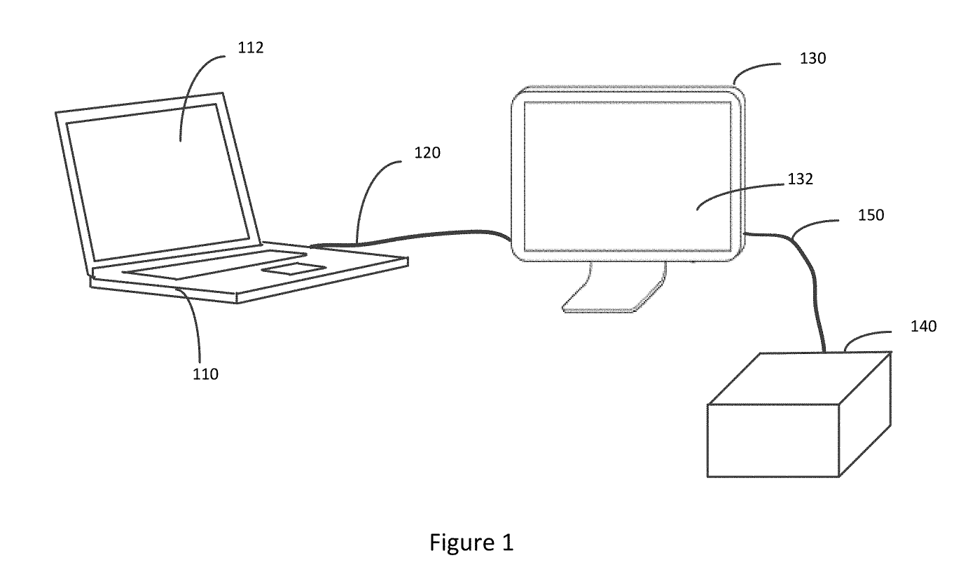

FIG. 1 illustrates an electronic system that may be improved by the incorporation of an embodiment of the present invention. This figure, as with the other included figures, is shown for illustrative purposes and does not limit either the possible embodiments of the present invention or the claims.

This example illustrates a monitor 130 that may be driven by one of two sources, specifically computer 110 or set-top box 140. Computer 110 may provide video data over cable 120 to monitor 130. Video data may be displayed on the video screen 132 of monitor 130. Computer 110 may similarly include screen 112. Set-top box 140 may provide video data over cable 150 to monitor 130. Again, this video data may be displayed on screen 132 of monitor 130. In other embodiments the present invention, other types of devices may be included, and other types of data may be shared or transferred among the devices. For example, monitor 130 may be a monitor, an all-in-one computer, tablet computer, or other device having screen 132. In these and other embodiments of the present invention, power may be shared among computer 110, monitor 130, and set-top box 140 over cable assemblies 120 and 150.

Cable assemblies 120 and 150 may be HDMI cable assemblies. These cable assemblies may include HDMI connector inserts (not shown) that plug into HDMI connector receptacles (not shown) on the computer 110, monitor 130, and set-top box 140. An example of a cable assembly according to an embodiment of the present invention is shown in the following figures.

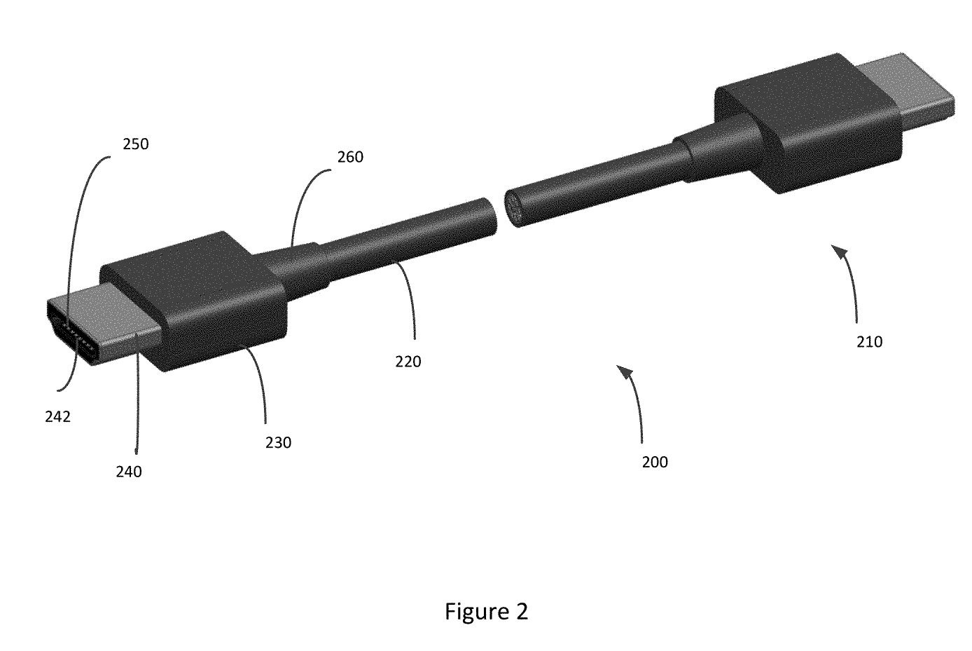

FIG. 2 illustrates a cable assembly according to an embodiment of the present invention. Cable assembly 200 may include connector inserts 210 at ends of cable 220. Connector inserts 210 may include an external housing 230, which may be grasped by a user during insertion into and extraction from a corresponding connector receptacle. Connector insert 210 may further include an insertion portion surrounded by front shell 240. Connector insert 210 may further include a front opening 242. Contacts 250 may be accessible at front opening 242 and may mate with contacts in a corresponding connector receptacle (not shown) when connector insert 210 is inserted into the connector receptacle.

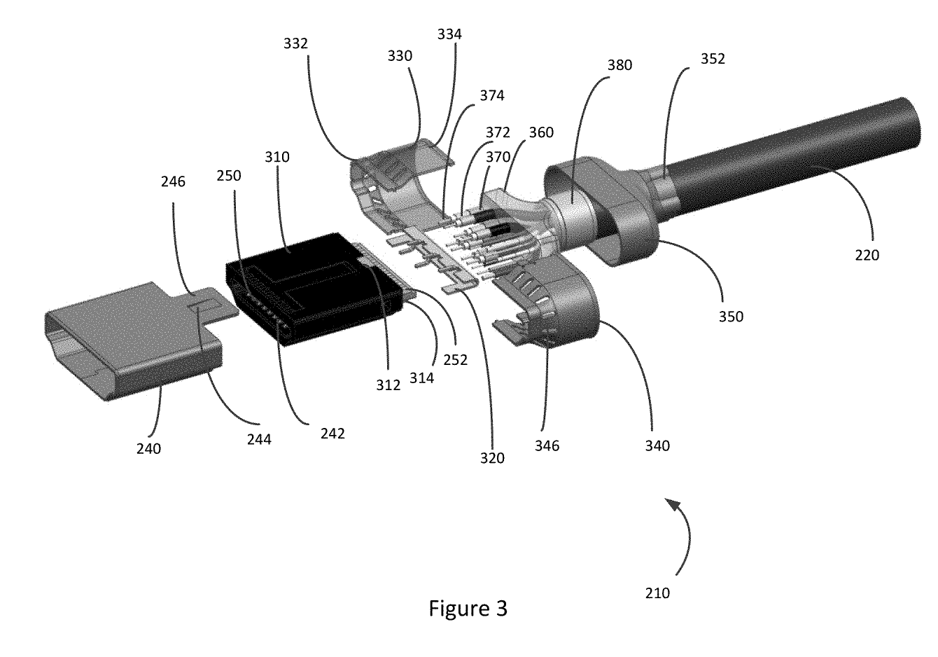

FIG. 3 is a top-side exploded view of a connector insert according to an embodiment of the present invention. In this example, connector insert 210 includes front shell 240. Front shell 240 may include extension 246 having tab 244. Internal housing 310 may support a plurality of contacts 250 that may be accessed at front opening 242 by a corresponding connector receptacle (not shown). Internal housing 310 may include notch 312 for accepting tab 244. Internal housing 310 may include a rear portion 314 supporting contact tails 252 of contacts 250. Cable 250 may include a number of conductors 370. Conductors 370 may be held in place by wire comb or block 360. Conductors 370 may be micro-coaxial wires or other types of conductors. Conductors 370 may have a jacket removed to expose shields 372. Conductors 370 may further include signal wires 374.

Ground bar 320 may be located between internal housing 310 and cable 220. Shields 372 of conductors 370 may be hot-bar soldered to ground bar 320. Similarly, signal wires 374 may be hot-bar soldered to contact tails 252 of contacts 250. These hot-bar soldering processes may occur at the same time, or they may be separate steps that occur in either order. Terminating shields 372 of conductors 370 with ground bar 320 may reduce insertion losses for the signals conveyed by conductors 370. Shields 372 may reduce cross-talk among signals conveyed by conductors 370 and may reduce the electromagnetic radiation generated by connector insert 210.

These soldered connections may be shielded by an internal shell. This internal shell may reduce radiation emitted from connector insert 210. The internal shell may also decrease the susceptibility of interference for the signals conveyed by this connector insert 210 from wired and wireless signals from nearby or associated devices. The internal shell may include a first shell portion 330 around a first side of ground bar 320 and wire comb 360 and a second shell portion 340 around a second side of ground bar 320 and wire comb 360. The internal shell may further include a rear shell portion 350. Rear shell portion 350 may include crimped portion 352 around cable 220. A front edge 332 of first and second shell portions 330 and 340 may fit over (or under) a rear portion of front shell 240 and be spot or laser welded along the resulting overlapping portion or otherwise fixed in place. A rear edge 334 of first and second shell portions 330 and 340 may fit under (or over) a front portion of rear shell 350 and be spot or laser welded along the resulting overlapping portion or otherwise fixed in place. First and second shell portions 330 and 340 may include slots 346 to reduce stiffness. Cable 220 may include an outside shield or braiding, which may be folded back and optionally secured with Mylar tape or other material as portion 380.

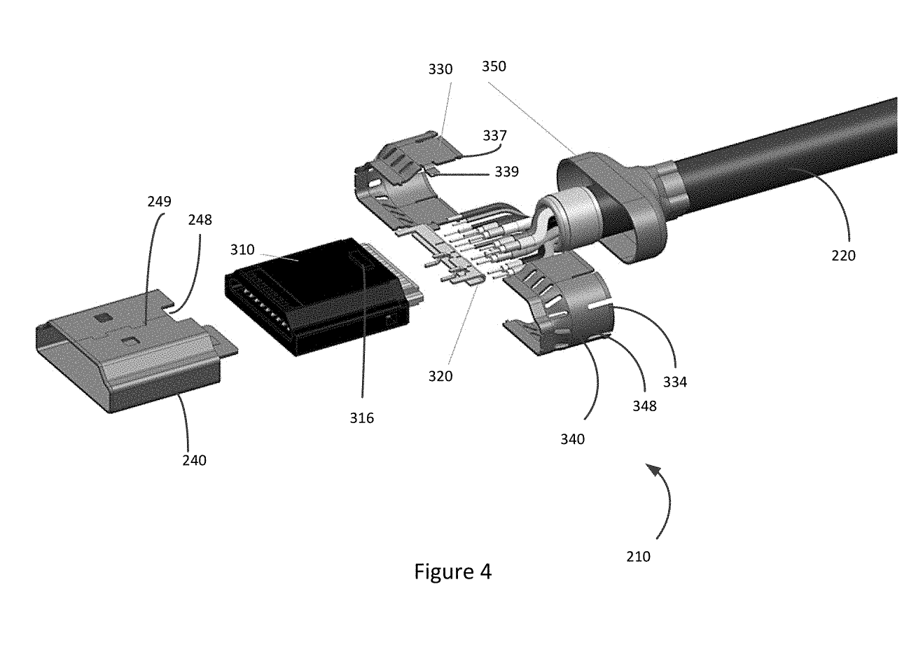

FIG. 4 is a bottom-side exploded view of a connector insert according to an embodiment of the present invention. Front shell 240 may include cutout 248 for accepting tab 316 on internal housing 310. Front shell 240 may include seam 249. Seam 249 may be notched as shown to reduce the length of any straight line segment. This may further help to reduce radiation generated by connector insert 210. Connector insert 210 may further include ground bar 320 located between internal housing 310 and cable 220. First and second shell portions 330 and 340 are shown in this example as having slots 348. Slots 348 may facilitate the insertion of rear portions 334 of first and second shell portions 330 and 340 under (or over) rear shell portion 350.

First shell portion 330 may include tabs 339. Tabs 339 may be spot or laser welded to the second shell portion 340. The presence of tabs 339 may reduce the length of a straight line segment of edges 337, thereby further reducing emissions generated by connector insert 210.

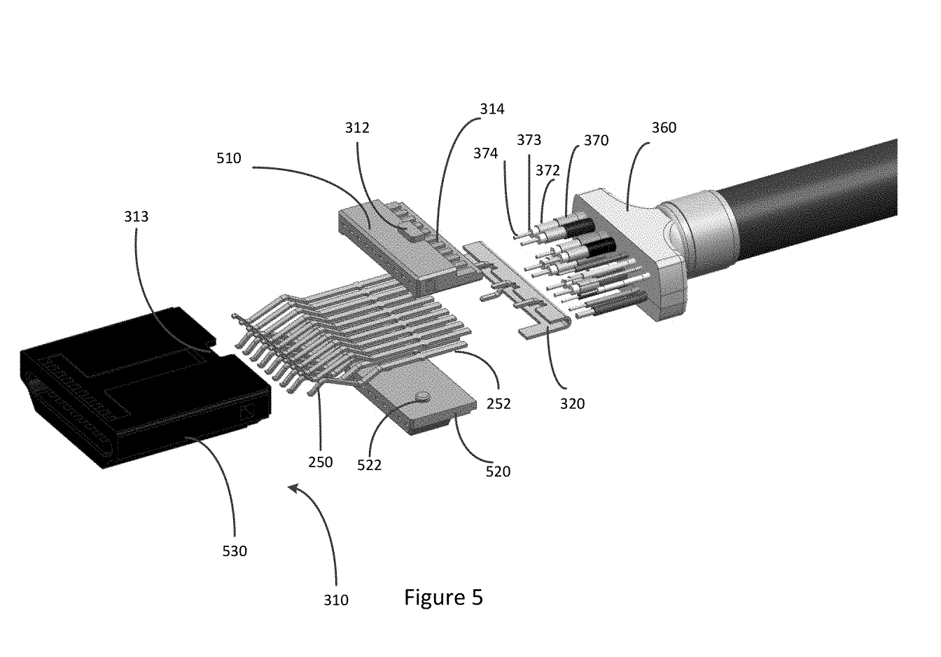

FIG. 5 illustrates an exploded view of a portion of a connector insert according to an embodiment of the present invention. In this example, internal housing 310 is shown as being formed of three internal housing portions. Specifically, a first internal housing portion 510 may be formed around portions of a first set of contacts 250 and a second internal housing portion 520 may be formed around a second set of contacts 250. In this example, the first set of contacts may be a top row of contacts in opening 242, while the second set of contacts may be a bottom row of contacts in opening 242. The first internal housing portion 510 and the second internal housing portion 520 may be formed by insert molding, while their contacts may be stamped. Second internal housing portion 520 may include tab 522 for fitting in a notch (not shown) in first internal housing portion 510 to join first internal housing portion 510 to second internal housing portion 520. First internal housing portion 510 and second internal housing portion 520 may be slid along with contacts 250 into third housing portion 530 to form internal housing 310. Tab 312 on first internal housing portion 510 may fit in notch 313 on third internal housing portion 520.

Conductors 370 may be secured in place using wire comb 360. Conductors 370 may have an external jacket removed exposing shielding 372. Shielding 372 may be removed exposing internal insulation 373. Internal insulation 373 may be removed exposing signal wire 374. These layers may be removed by laser cutting or other technique. As shown before, shields 372 may be hot-bar soldered or otherwise fixed to ground bar 320, while signal wires 374 may be hot-bar soldered or otherwise fixed to contact tails 252 of contacts 250.

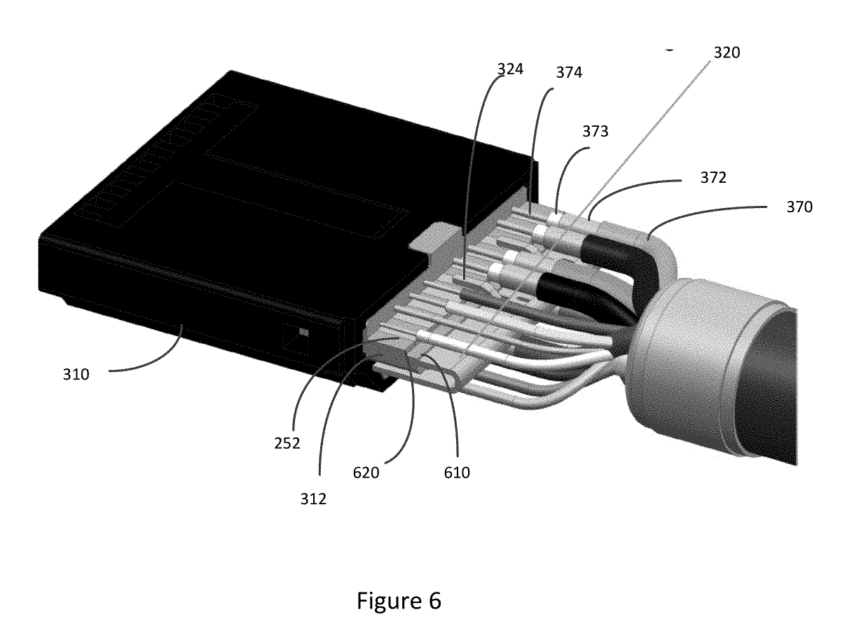

FIG. 6 illustrates a portion of a connector insert according to embodiments of the present invention. In this example, internal housing 310 may include rear portion 312 supporting contact tails 252. Contact tails 252 may be hot bar soldered to signal wires 374. Tabs 324 on ground bar 320 may also be soldered to contact tails 252 of ground contacts in the HDMI connector.

Conductors 370 may include shielding 372, internal insulation layer 373, and signal wires 374. An outer jacket may be removed from conductor 370 to expose shielding 372. Shielding 372 may be removed to expose internal insulation 373. Internal insulation 373 may be removed to expose signal wires 374. As each of these layers is removed, the conductor may have a reduced width. Accordingly, rear portion 312 of internal housing 310 and ground bar 320 may include or form steps 610 and 620. Steps 610 and 620 may be arranged such that the signal wire 374 of conductors 370 may lay relatively flat, thereby simplifying assembly and improving reliability. Specifically, step 610 between ground bar 320 and a rear 312 of internal housing 310 may compensate for a step between internal insulation 373 and shielding 372 of conductor 370. Similarly, rear portion 312 of internal housing 310 may include steps 620. Step 620 may compensate for a step between internal insulation 373 and signal wire 374.

In these and other embodiments of the present invention, conductors 370 may be coaxial wires, such as micro-coaxial wires. Use of these cables may provide a high level of isolation between high-speed signals conveyed using cable assemblies according to the present invention. The use of micro-coaxial wires may also reduce the susceptibility of these high-speed signals to noise from external sources, from either within the cable assembly or from wired or wireless signals for devices near or associated with the cable assembly.

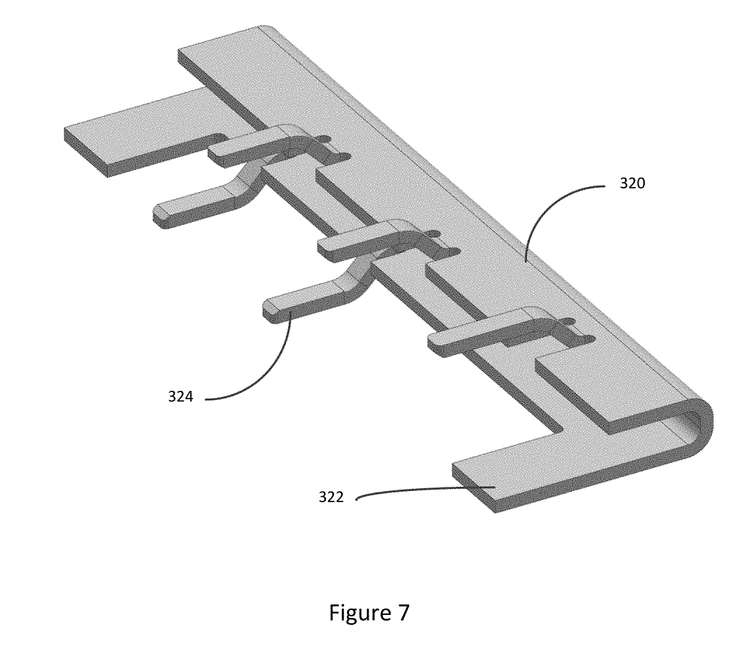

FIG. 7 illustrates a ground bar according to an embodiment of the present invention. Ground bar 320 may have a general U-shape. Ground bar 320 may include ground contacts 324. Ground contacts 324 may be soldered to contact tails 252 of ground contacts in the connector insert 210. Ground bar 320 may further include alignment features 322. Alignment features 322 may fit in corresponding slots in rear 314 of internal housing 310. This arrangement may secure the ground bar 320 in place during assembly. Ground bar 320 may include one or more openings to act as heat breaks or thermal breaks to prevent heat from dissipating too quickly when shields of conductors 370 are soldered to ground bar 320.

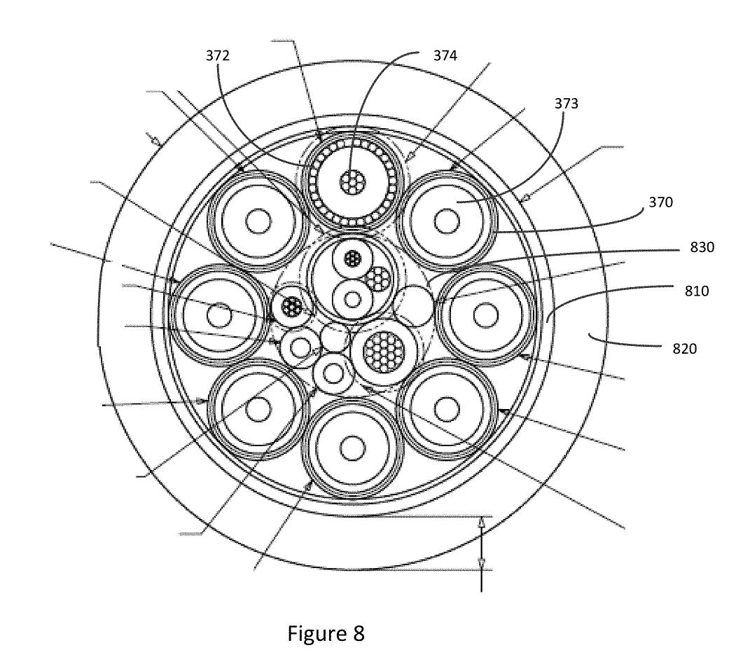

FIG. 8 illustrates a cross-section of a cable according to an embodiment of the present invention. In this example, cable 220 may include a number of conductors 370 placed around an outside perimeter of cable 220. Conductors 370 may be micro-coaxial wires or other types of coaxial wires. Conductors 370 may include signal wires 374, which may be made up of a number of individual wire strands. Signal wires 374 may be insulated by internal insulation 373, which may be surrounded by shielding 372. Shielding 372 may be wrapped with aluminum or copper Mylar. Conductors 370 may surround a central portion 830, which may include power supply, ground, and other wires for an HDMI or other interface. The resulting cable bundle may be secured by a layer of Mylar tape 810, which may be surrounded by jacket 820. To reduce skew, the conductors 370 may be trimmed to be the same length and may be manufactured to have the matched impedances. They may also be positioned to be the same or similar distance from a center of cable 220. In in this example, eight micro-coaxial wires may be used to convey four differential signal pairs. These or other types of conductors may be used to convey power, ground, and other signals.

In these and other embodiments of the present invention, it may be desirable to provide a thin cable. One feature that may generally increase a thickness of the cable is a strain relief. A strain relief in general prevents a cable from being bent at a single point and instead distributes the radius of the bend along a greater length of the cable. Distributing the bend radius in this way reduces local stress and improves reliability of the cable. Conventional strain reliefs may be located around an outside of a cable, which again may make the cable undesirably thick.

Accordingly, embodiments of the present invention may provide an internal strain relief for a cable. An example is shown in the following figures.

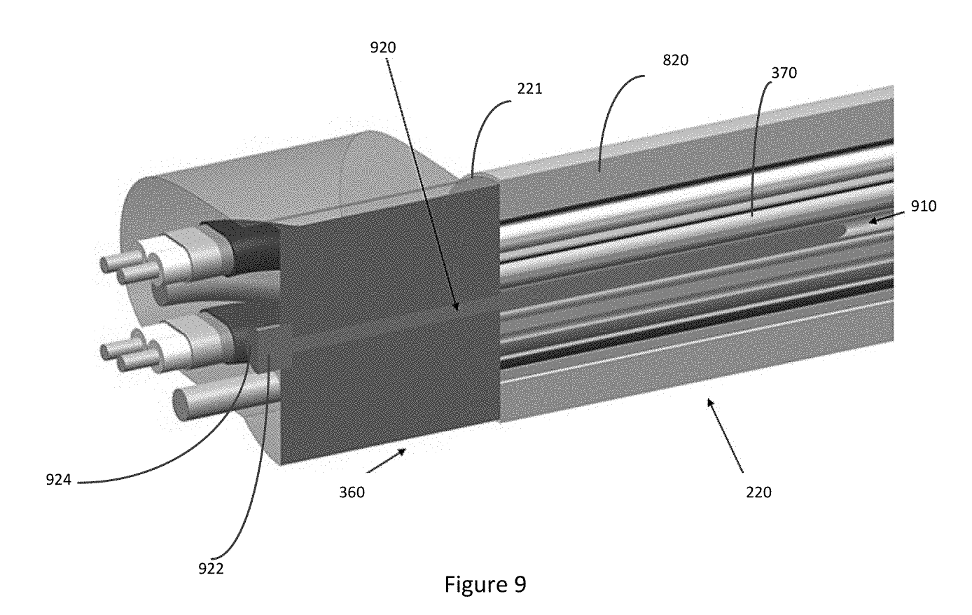

FIG. 9 illustrates an internal strain relief according to an embodiment of the present invention. Without a strain relief, as cable 220 bends relative to a connector insert housing, represented here by wire comb 360, the bend may primarily occur at location 221. The localized stress caused by this short bend radius may damage cable 220. Accordingly, embodiments of the present invention may include an internal strain relief that distributes the bend radius along a longer length. This distribution may help to avoid damage to cable 220.

In this example, cable 220 may include a hollow tube 910. Hollow tube 910 may be located at least approximately at a center of cable 220, though it may be located at other positions in cable 220 in these and other embodiments of the present invention. A rod or spike 920 may be inserted into an end of hollow tube 920. Rod 920 may be less flexible than hollow tube 910. This arrangement may distribute a bend radius along the length of rod 920, thereby protecting cable 220. Hollow tube 910 may further protect conductors 370 from rod 920. Rod 920 may be made of stainless steel, spring tempered steel, nickel titanium (nitinol), or other metal or other material. Hollow tube 910 may be made of ethylene tetrafluoroethylene (ETFE), nylon, plastic, or other material. Hollow tube 910 may be extruded and bundled along with conductors 370 when cable 220 is manufactured. Rods 920 may be inserted into ends of hollow tube 910 using a tool or assembly fixture.

During assembly, rod 920 may be inserted into hollow tube 910. Wire comb 360 may be molded around rod 920 and ends of conductors 370. Rod 920 may include a wider front portion 922, which may help secure rod 920 in place in wire comb 360. A front surface 924 of rod 920 may be deburred to avoid abrasion of conductors 370.

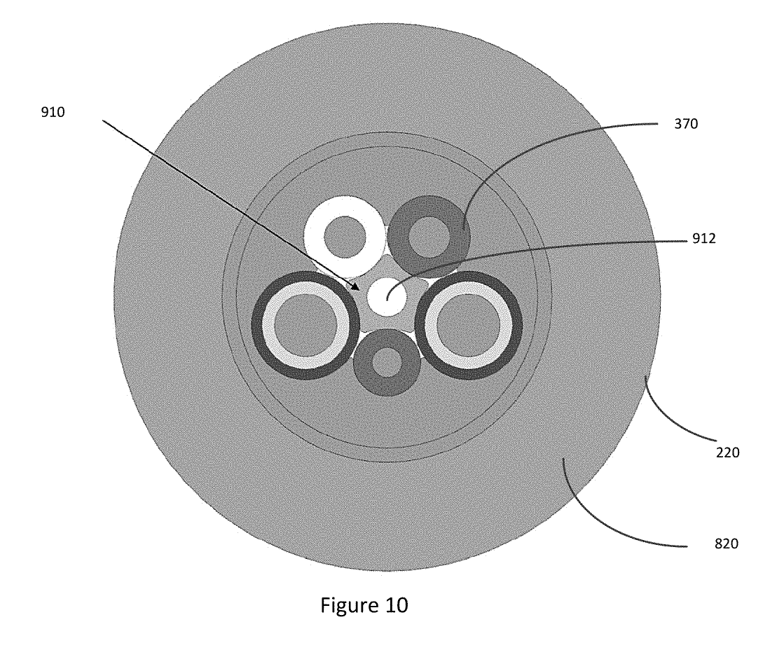

FIG. 10 illustrates a cross-section of a cable including an internal strain relief according to an embodiment of the present invention. In this example, the internal strain relief may include hollow tube 910, which may have a central passage 912. Rod 920 (not shown) may be inserted into central passage 912 during assembly as described above. Conductors 370 may be positioned against an outside edge of hollow tube 910 during assembly. Conductors 370 may be encased in jacket 820 to form cable 220.

In this example, hollow tube 910 may have a star shaped cross-section. In these and other embodiments of the present invention, hollow tube 910 may have a circular or other shaped cross-section. In these and other embodiments of the present invention, hollow tube 910 and rods 920 may be replaced by a plastic or nylon rod (not shown), which may run the length or a portion or portions of the length of the cable. For example, the plastic or nylon rod portions may be located near ends of cable 220.

While embodiments of the present invention may be useful in HDMI cable assemblies, these and other embodiments of the present invention may be used in other types of cable assemblies for different interfaces.

In various embodiments of the present invention, contacts, shells, ground bars, and other conductive portions of a cable assembly may be formed by stamping, metal-injection molding, machining, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions, such as the housings, internal housings, and other structures may be formed using injection or other molding, 3-D printing, machining, or other manufacturing process. The nonconductive portions may be formed of silicon or silicone, rubber, hard rubber, plastic, nylon, liquid-crystal polymers (LCPs), ceramics, or other nonconductive material or combination of materials.

Embodiments of the present invention may provide cable assemblies and connector inserts that may connect to various types of devices, such as portable computing devices, tablet computers, desktop computers, laptops, all-in-one computers, wearable computing devices, cell phones, smart phones, media phones, storage devices, portable media players, navigation systems, monitors, power supplies, video delivery systems, adapters, remote control devices, chargers, and other devices. These cable assemblies may provide pathways for signals that are compliant with various standards such as one of the Universal Serial Bus standards including USB Type-C, one of the HDMI standards, such as 1.4 or 2.0, Digital Visual Interface, Ethernet, DisplayPort, Thunderbolt, Lightning, Joint Test Action Group, test-access-port, Directed Automated Random Testing, universal asynchronous receiver/transmitters, clock signals, power signals, and other types of standard, non-standard, and proprietary interfaces and combinations thereof that have been developed, are being developed, or will be developed in the future. Other embodiments of the present invention may provide cable assemblies that may be used to provide a reduced set of functions for one or more of these standards. In various embodiments of the present invention, these interconnect paths provided by these cable assemblies may be used to convey power, ground, signals, test points, and other voltage, current, data, or other information.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A cable assembly comprising:
a cable having a plurality of micro-coaxial wires, each micro-coaxial wire having a signal wire and a shield;
a plurality of contacts, each having a contact tail and a contacting portion, the contacting portion to mate with a corresponding contact in a corresponding connector receptacle;
an internal housing supporting the plurality of contacts, such that the contact tails are exposed at a rear of the internal housing; and
a ground bar between the internal housing and the cable, where the shield of each of the plurality of micro-coaxial wires is soldered to the ground bar and the signal wire of each of the plurality of micro-coaxial wires is soldered to a corresponding contact tail of one of the plurality of contacts.

2. The cable assembly of claim 1 wherein the ground bar includes an alignment feature to align the ground bar to the internal housing.

3. The cable assembly of claim 2 further comprising an internal shell around the ground bar.

4. The cable assembly of claim 3 wherein the internal housing comprises a first internal housing portion around a portion of each contact in a first set of contacts in the plurality of contacts, a second internal housing portion around a portion of each contact in a second set of contacts in the plurality of contacts, and a third internal housing portion.

5. The cable assembly of claim 4 wherein the first internal housing portion includes tabs to fit with notches in the second internal housing portion, and the first housing portion and the second housing portion fit in an opening in the back of the third internal housing portion.

6. The cable assembly of claim 5 further comprising a shell around the internal housing.

7. The cable assembly of claim 6 further comprising an external housing around a rear of the internal housing, the ground bar, and the internal shell.

8. A cable assembly comprising:
a cable comprising a plurality of coaxial wires, each coaxial wire having a signal wire and a shield;
an internal housing supporting a plurality of contacts to mate with a corresponding plurality of contacts in a corresponding connector receptacle;
a shell around the internal housing;
a ground bar between the internal housing and the cable, where the shield of each of the plurality of coaxial wires is soldered to the ground bar and the signal wire of each of the plurality of coaxial wires is soldered to a corresponding contact tail of one of the plurality of contacts;
a wire comb formed around a portion of each of the plurality of coaxial wires; and
an internal shell around the ground bar and the wire comb.

9. The cable assembly of claim 8 wherein the internal shell comprises a first side portion around a first end of the ground bar, a second side portion around a second end of the ground bar, and a rear portion around the cable.

10. The cable assembly of claim 9 wherein the rear portion of the internal shell is crimped to the cable.

11. The cable assembly of claim 8 wherein the plurality of coaxial wires comprises a plurality of micro-coaxial wires.

12. The cable assembly of claim 8 wherein the internal housing comprises a first internal housing portion around a portion of a first set of contacts in the plurality of contacts, a second internal housing portion around a portion of a second set of contacts in the plurality of contacts, and a third internal housing portion.

13. The cable assembly of claim 12 wherein the first internal housing portion includes tabs to fit with notches in the second internal housing portion, and the first housing portion and the second housing portion fit in an opening in the back of the third internal housing portion.

14. The cable assembly of claim 8 further comprising an external housing around a rear of the internal housing, the ground bar, the wire comb, and the internal shell.

15. A cable comprising:
a plurality of conductors;
an internal strain relief comprising:
a hollow tube having a first end and a second end; and
a first rod in the first end of the hollow tube; and
a jacket around the plurality of conductors and the hollow tube.

16. The cable of claim 15 further comprising a second rod in a second end of the hollow tube.

17. The cable of claim 15 wherein the hollow tube is located in the center of the cable.

18. The cable of claim 17 wherein the hollow tube has a star-shaped cross section.

19. The cable of claim 17 wherein the hollow tube has a circular cross section.

20. The cable of claim 17 wherein the plurality of conductors comprises a plurality of micro-coaxial wires.
